(19) United States
(12) Patent Application Publication
(10) Pub. No.: US 2011/0282564 A1
(43) Pub. Date: Nov. 17, 2011

(54) VEHICLE MANAGEMENT SYSTEM

(75) Inventors: Byoung Jae Park, Ulsan (KR); Chang Euk Jang, Seoul (KR)

(73) Assignee: HYUNDAI MOTOR COMPANY, Seoul (KR)

(21) Appl. No.: 12/839,513

(22) Filed: Jul. 20, 2010

(30) Foreign Application Priority Data
May 14, 2010 (KR) 10-2010-0045457

(51) Int. Cl. G06F 19/00

(52) U.S. Cl. 701/117

(57) ABSTRACT

A vehicle management system is provided, which includes an RFID tag storing vehicle information, a mobile vehicle management device generating management information from position information and the vehicle information received from the outside, and a server generating operation information by analyzing the management information.

### CROSS-REFERENCE TO RELATED APPLICATION

This application is based on and claims priority from Korean Patent Application No. 10-2010-0045457, filed on May 14, 2010 in the Korean Intellectual Property Office, the disclosure of which is incorporated herein in its entirety by reference.

### BACKGROUND OF THE INVENTION

1. Field of the Invention

The present invention relates, generally, to a vehicle management system.

2. Description of the Prior Art

Typically, no separate automated system exists in places where a large number of vehicles are managed, such as an export vehicle shipyard, a vehicle freight station, a long-term airport parking lot, for example.

In order to manage a large number of vehicles, a person marks an inherent vehicle identification number on a vehicle.

In the case of moving a vehicle, a driver, who has moved the corresponding vehicle, may enter an inherent identification number of the moved car, the position of the car before movement, and the position of the car after movement in a book, and then directly input the information to a management system later.

Further, in the case of moving a vehicle, a driver, who has moved the corresponding vehicle, may input, on the spot, an inherent identification number of the moved car, the position of the car before movement, and the position of the car after movement to a management system through a mobile communication terminal.

However, in the case of managing a large number of vehicles, for example, tens of thousands of vehicles, a driver should directly input a moving path of a vehicle whenever the driver moves a vehicle.

Further, if the driver wrongly inputs the position of a vehicle, it is actually impossible to find where the specified vehicle is located among the tens of thousands of vehicles.

Accordingly, there remains a need in the art for a system that automatically manages vehicles.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In preferred aspects, the present invention features systems and methods that automatically manage vehicles using vehicle position information and vehicle information.

In preferred embodiments of the present invention, there is provided a vehicle management system, which preferably includes an RFID tag storing vehicle information; a mobile vehicle management device generating management information from position information and the vehicle information received from the outside; and a server generating operation information by analyzing the management information.

Preferably, with the above-described configuration, the vehicle management system according to an embodiment of the present invention can seize the present and past position, and a moving path of a specified vehicle using vehicle position information and vehicle information.

Further, the vehicle management system according to preferred embodiments of the present invention can automatically manage a large number of vehicles using vehicle position information and vehicle information.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features and advantages of the present invention will be more apparent from the following detailed description taken in conjunction with the accompanying drawings, in which:

FIG. 1 is a diagram illustrating a vehicle management system according to an embodiment of the present invention;

FIG. 2 is a diagram illustrating the configuration of a mobile vehicle management device in a vehicle management system according to an embodiment of the present invention;

FIG. 3 is a diagram illustrating the configuration of a server in a vehicle management system according to an embodiment of the present invention;

FIG. 4 is a diagram illustrating the configuration of a vehicle management center in a vehicle management system according to an embodiment of the present invention;

FIG. 5 is a diagram illustrating a picture displayed on a display unit of a vehicle management center in a vehicle management system according to an embodiment of the present invention;

FIG. 6 is a graph showing a process in which a mobile vehicle management device recognizes the movement of a vehicle in a vehicle management system according to an embodiment of the present invention;

FIG. 7 is a graph showing another process in which a mobile vehicle management device recognizes the movement of a vehicle in a vehicle management system according to an embodiment of the present invention;

FIG. 8 is a graph showing still another process in which a mobile vehicle management device recognizes the movement of a vehicle in a vehicle management system according to an embodiment of the present invention;

FIG. 9 is a diagram illustrating the configuration of another example of a vehicle management center in a vehicle management system according to an embodiment of the present invention; and

FIG. 10 is a diagram illustrating the configuration of still another example of a vehicle management center in a vehicle management system according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

As described herein, the present invention features a vehicle management system comprising an RFID tag storing vehicle information, a mobile vehicle management device, and a server that generates operation information.

In one embodiment, the mobile vehicle management device generates management information from position information and the vehicle information received from the outside.

In another embodiment, the server generates operation information by analyzing the management information.

Hereinafter, preferred embodiments of the present invention will be described in greater detail with reference to the accompanying drawings.

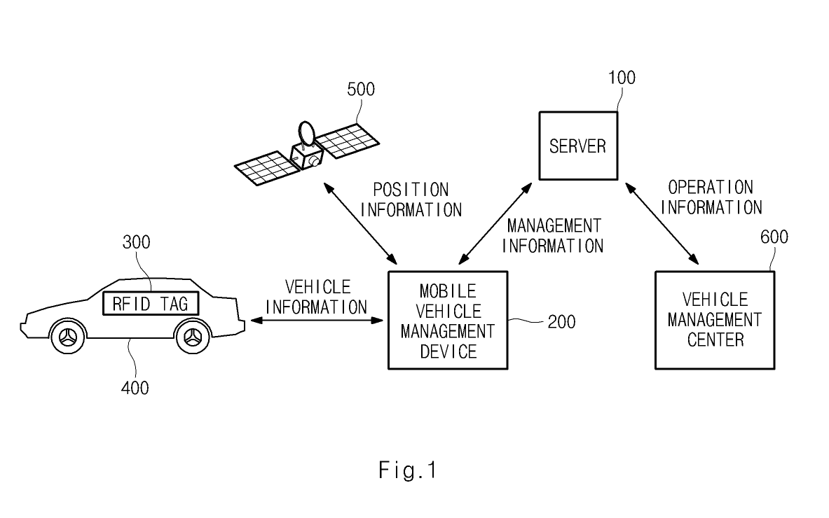

FIG. 1 is a diagram illustrating a vehicle management system according to an embodiment of the present invention.

In certain exemplary embodiments, and referring to FIG. 1, a vehicle management system according to an embodiment of the present invention preferably includes a server 100, a mobile vehicle management device 200, an RFID tag 300, a vehicle 400, a satellite 500, and a vehicle management center 600.

According to certain preferred embodiments, the vehicle management system according to an embodiment of the present invention stores vehicle information of the vehicle 400 in the RFID tag 300.

Preferably, the vehicle information indicates an inherent identification number of the vehicle 400. For example, according to certain exemplary embodiments, the vehicle information may be a serial number of a bar code that is suitably indicated when the vehicle is delivered. Different numbers are given to different vehicles, respectively.

The RFID tag 300 may preferably be installed inside the vehicle 400. For example, it may be installed in the neighborhood of a room mirror of the vehicle. In other exemplary embodiments, the RFID tag 300 may be installed outside the vehicle 400. For example, it may be installed at an upper end of the center of a front glass of the vehicle 400. However, the position of the RFID tag 300 is not limited thereto, and the RFID tag 300 may be suitably installed at any place inside/outside the vehicle 400 where the efficiency of communication with an RFID reader is high.

According to still further preferred embodiments of the present invention, the mobile vehicle management device 200 preferably includes an RFID reader 210. Preferably, the RFID reader 210 of the mobile vehicle management device 200 receives vehicle information that is suitably transmitted from the RFID tag 300.

According to other certain embodiments, the mobile vehicle management device 200 preferably receives position information from the satellite 500. For example, in certain exemplary embodiments, the position information may be GPS coordinates of the mobile vehicle management device 200.

The vehicle management system according to an embodiment of the present invention receives position information in order to seize the position of a vehicle 400. Accordingly, in certain exemplary embodiments, it is preferable that the mobile vehicle management device 200 is close to the vehicle 400. Preferably, the mobile vehicle management device 200 may be set to suitably receive the position information when the mobile vehicle management device is within a predetermined distance from the RFID tag 300 installed in the vehicle 400.

For example, according to certain preferred embodiments, it is assumed that a vehicle having the mobile vehicle management device 200 mounted thereon passes by in a place where a large number of vehicles stand close together such as an export vehicle shipyard. If the vehicle having the mobile vehicle management device 200 mounted thereon passes by, the RFID reader 210 of the mobile vehicle management device 200 communicates with RFID tags 300 installed in the vehicles 400 which are within the predetermined distance from the mobile vehicle management device 200 to transmit/receive the vehicle information.

Preferably, when the vehicle information is transmitted from the vehicle 400, the mobile vehicle management device 200 receives the position information from the satellite 500, and matches the vehicle information to the position information.

For example, according to certain preferred embodiments, if it is assumed that the mobile vehicle management device 200 passes by a vehicle (inherent identification number: K2341) that is parked in an A-32 block of a first area of the export vehicle shipyard, the mobile vehicle management device 200 suitably receives the inherent identification number that is the vehicle information from the vehicle, and also receives the GPS coordinates which are the position information corresponding to the A-32 block of the first area from the satellite 500. Preferably, the mobile vehicle management device 200 combines the information and generates management information. According to still other further preferred embodiments, the mobile vehicle management device 200 may simultaneously generate respective management information with respect to the large number of vehicles.

In other further exemplary embodiments, and as another example, it is assumed that a driver who carries the mobile vehicle management device 200 passes by in a place where a large number of vehicles stand close together such as an export vehicle shipyard. preferably, if the driver who carries the mobile vehicle management device 200 gets into a specified vehicle to move the vehicle to a predetermined place, the RFID reader 210 of the mobile vehicle management device 200 communicates with the RFID tag 300 installed in the corresponding vehicle to transmit/receive the vehicle information.

Preferably, when the vehicle information is transmitted from the vehicle 400, the mobile vehicle management device 200 suitably receives the position information from the satellite 500, and matches the vehicle information to the position information.

For example, in certain exemplary embodiments, if it is assumed that the driver who carries the mobile vehicle management device 200 gets into a vehicle (inherent identification number: K1823) that is parked in a B-42 block of a third area of the export vehicle shipyard, the mobile vehicle management device 200 suitably receives the inherent identification number that is the vehicle information from the vehicle, and also receives the GPS coordinates which are the position information corresponding to the B-42 block of the third area from the satellite 500. Preferably, the mobile vehicle management device 200 combines the information and generates management information. In other further preferred embodiments, the mobile vehicle management device 200 may simultaneously generate respective management information with respect to the large number of vehicles.

Preferably, the server 100 receives the management information from the mobile vehicle management device 200. Various communication methods can be used between the server 100 and the mobile vehicle management device 200.

According to further exemplary embodiments of the present invention, the server 100 suitably analyzes the vehicle information and the position information for each time zone by analyzing the management information.

For example, the server 100 seizes the position of the vehicle (inherent identification number: K4124) at 10:30:23 PM and the position of the vehicle (inherent identification number: K4124) at 10:30:24 PM. If the vehicle (inherent identification number: K4124) is moved 5 m for one second, the server 100 can suitably recognize that the moving speed of the vehicle (inherent identification number: K4124) is 5 m/s.

As described herein, in an embodiment of the present invention, the server 100 of the vehicle management system suitably identifies a specified vehicle among a large number of vehicles through the vehicle information, and suitably generates various information such as the speed of the vehicle, the moving path of the vehicle, and the like, by analyzing the position of the moved vehicle and the elapse of time.

Preferably, such information generated by the server 100 is defined as operation information.

Preferably, in certain exemplary embodiments, the operation information generated by the server 100 is suitably transmitted to the vehicle management center 600.

According to still further preferred embodiments, the vehicle management center 600 analyzes and provides the operation information to a user.

For example, in certain exemplary embodiments, the vehicle management center 600 can provide information on which position the specified vehicle is currently in, how the moving path of the specified vehicle is, from where to where the specified vehicle is currently moving, and the like, to the user.

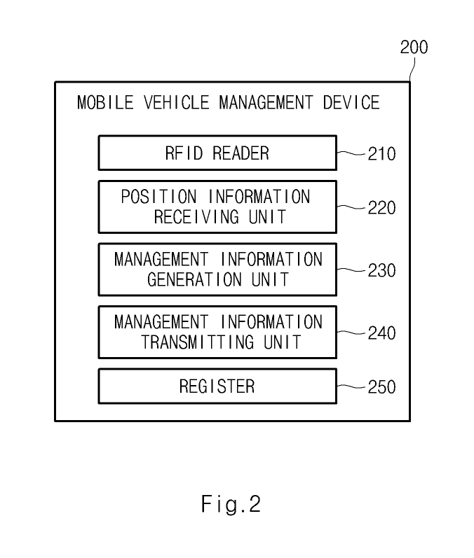

According to certain exemplary embodiments and as shown in FIG. 2, for example, FIG. 2 is a diagram illustrating the configuration of a mobile vehicle management device 200 in a vehicle management system according to a preferred embodiment of the present invention.

Referring to FIG. 2, for example, the mobile vehicle management device 200 of the vehicle management system according to an embodiment of the present invention preferably includes an RFID reader 210, a position information receiving unit 220, a management information generation unit 230, a management information transmitting unit 240, and a register 250.

Preferably, in certain embodiments, the RFID reader 210 receives the vehicle information by communicating with the RFID tag 300 of the vehicle 400. As described herein, the vehicle information may be the inherent identification number of the vehicle 400.

According to still further preferred embodiments, the position information receiving unit 220 receives the position information from the satellite 500 or the server that provides the position information. As described herein, the position information may be the GPS coordinates that are received from the satellite 500.

According to further preferred embodiments of the present invention, the management information generation unit 230 suitably generates the management information using the vehicle information and the position information. Preferably, the management information indicates the position information of a specified vehicle with the lapse of time.

Preferably, the management information transmitting unit 240 suitably transmits the management information generated by the management information generation unit 230 to the server 100. Preferably, the management information transmitting unit 240 can transit the management information using various communication methods.

According to preferred embodiments of the present invention, the register 250 stores the management information. Preferably, a memory may be used as the register. For example, a flash memory, a ROM, a ferroelectric memory, a phase-change memory, STT-RAM, or the like, may be used as the register 250.

Further, the register 250 can store not only the management information but also the vehicle information and the position information for each time for the backup of data.

In the following description, according to certain exemplary embodiments, the detailed processes in which the mobile vehicle management device 200 receives the vehicle information and the position information and generates and transmits the management information are exemplified.

According to certain preferred embodiments, the vehicle management system according to an embodiment of the present invention is suitably applied to a place in which a large number of vehicles should be managed, such as, but not limited to, an export vehicle shipyard, a vehicle freight station, a long-term airport parking lot, for example, or the like.

Preferably, if the mobile vehicle management device 200 approaches a place where a large number of vehicles are parked, the vehicle information of the respective vehicles 400 are suitably transmitted from the RFID tags 300 of the adjacent vehicles 400.

According to certain preferred embodiments, the RFID reader 210 of the mobile vehicle management device 200 simultaneously or sequentially receives one or more vehicle information.

Preferably, when the RFID reader 210 of the mobile vehicle management device 200 receives the vehicle information, the position information receiving unit 220 of the mobile vehicle management device 200 receives the position information from the satellite 500.

According to certain preferred embodiments, the management information generation unit 230 combines the vehicle information received from the respective vehicles 400 with the position information, and suitably generates the management information.

For example, in certain preferred embodiments, the mobile vehicle management device 200 suitably receives the inherent identification number (M9119) that is the vehicle information from the vehicle, and receives the GPS coordinates from the satellite 500. Preferably, the management information generation unit 230 generates the management information by combining the above-described information. Preferably, the management information indicates the position of a specified vehicle for each time zone.

According to further preferred embodiments, the management information generation unit 230 generates the inherent management information for each vehicle and stores the generated management information in the register 250.

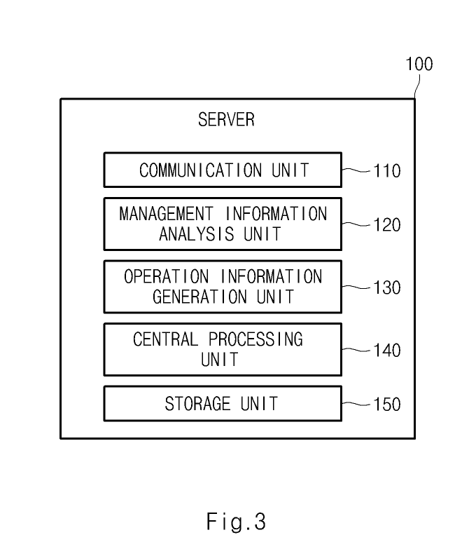

According to certain exemplary embodiments and as shown in FIG. 3, for example, FIG. 3 is a diagram illustrating the configuration of a server 100 in a vehicle management system.

Referring to FIG. 3, the server 100 of the vehicle management system according to an embodiment of the present invention preferably includes a communication unit 110, a management information analysis unit 120, an operation information generation unit 130, a central processing unit 140, and a storage unit 150.

In the vehicle management system according to an embodiment of the present invention, the communication unit 110 suitably receives the management information from the management information transmitting unit 240 of the mobile vehicle management device 200.

Preferably, various communication methods may be used between the communication unit 110 and the management information transmitting unit 240.

For example, various communication methods such as 2G, 3G, LTE, WIBRO, WiFi, and the like, can be used.

According to certain preferred embodiments of the present invention, the management information analysis unit 120 suitably analyzes the received management information. Preferably, the management information analysis unit 120 analyzes the vehicle information and the position information for each time zone by analyzing the management information.

For example, in certain exemplary embodiments, the management information analysis unit 120 seizes the position of the vehicle (inherent identification number: K4124) at 10:30:23 PM and the position of the vehicle (inherent identification number: K4124) at 10:30:24 PM. Preferably, if the vehicle (inherent identification number: K4124) is moved 5 m for one second, the management information analysis unit 120 can suitably recognize that the moving speed of the vehicle (inherent identification number: K4124) is 5 m/s.

As another example, according to certain exemplary embodiments, the management information analysis unit 120 seizes the position of the vehicle (inherent identification number: K4124) on November 1 and the position of the vehicle on November 2, and thus can recognize the moving path of the vehicle. That is, in certain preferred embodiments, the management information analysis unit 120 can recognize that the vehicle was located in the A-32 block of the first area on November 1, and the vehicle was located in the A-34 block of the third area on November 2.

According to other further preferred embodiments, the operation information generation unit 130 suitably generates operation information by categorizing the results of analysis of the management information.

For example, the operation information generation unit 130 can suitably generate information on the moving speed for each time zone of a specified vehicle in a category called a moving speed of a vehicle among the operation information. Also, the operation information generation unit 130 can suitably generate information on the moving path for each time zone of a specified vehicle in a category called a moving path of a vehicle among the operation information.

Preferably, the central processing unit 140 assists the detailed operations performed by the communication unit 110, the management information analysis unit 120, the operation information generation unit 130, and the storage unit 150.

Since the vehicle management system according to an embodiment of the present invention manages a large number of vehicles and generates lots of information in the unit of a second, quick operation is preferably required. In this case, lots of operations can be quickly performed through the central processing unit 140.

According to other preferred embodiments of the present invention, the operation information generated by the operation information generation unit 130 is suitably transmitted to the vehicle management center 600 through the communication unit 110.

By contrast, in other further embodiments, the communication unit 110 may be requested to send the operation information to the vehicle management center 600.

For example, in certain exemplary embodiments, if the vehicle management center 600 inquires about the current position of a specified vehicle, the central processing unit 140 searches for the corresponding information in the operation information stored in the storage unit 150. Preferably, the central processing unit 140 transmits the search result to the vehicle management center 600 through the communication unit 110.

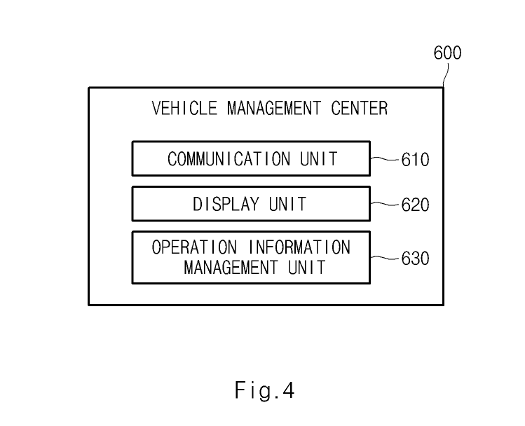

According to certain exemplary embodiments and as shown in FIG. 4, for example, FIG. 4 is a diagram illustrating the configuration of a vehicle management center 600 in a vehicle management system according to an exemplary embodiment of the present invention.

Referring to FIG. 4, the vehicle management center 600 of the vehicle management system according to an embodiment of the present invention preferably includes a communication unit 610, a display unit 620, and an operation information management unit 630.

According to certain preferred embodiments, the communication unit 610 communicates with the communication unit 110 of the server 100 to receive the operation information. Further, the communication unit 610 may suitably request desired operation information from the server 100.

Preferably, the display unit 620 displays the operation information received from the server 100.

For example, according to certain preferred embodiments, the display unit 620 may be a visual display device such as a monitor, an output device such as a printer, and an audio output device notifying the result with audio.

According to further preferred embodiments, the operation information management unit 630 serves to suitably store the operation information received from the server 100 and edits the received operation information in accordance with a user's intention.

For example, in preferred exemplary embodiments, it is assumed that a user desires to know the moving path of a specified vehicle from 10:00 AM to 2:00 PM. Preferably, the operation information management unit 630 transmits such a request to the server 100 through the communication unit 610, and receives the operation information that corresponds to the search result from the server 100. Preferably, the operation information management unit 630 may edit the operation information to suit the user and provide the edited operation information through the display unit 620.

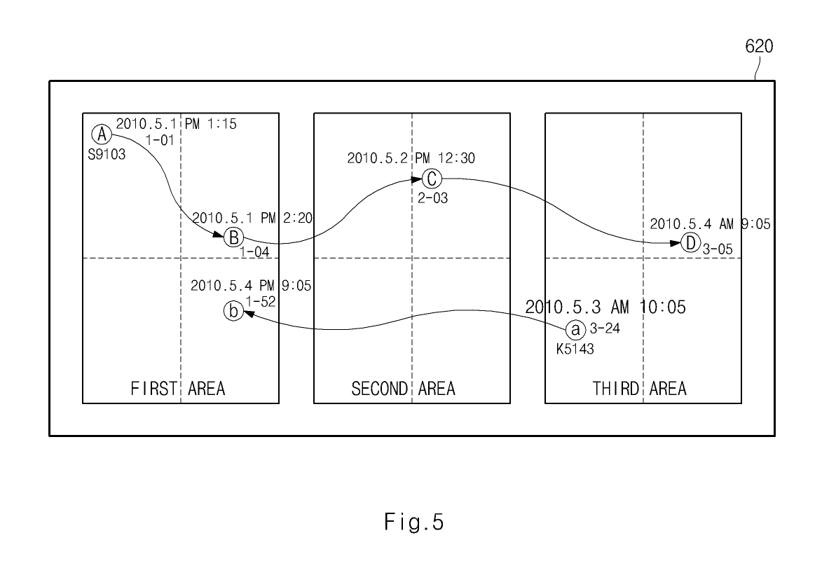

According to certain exemplary embodiments and as shown in FIG. 5, for example, FIG. 5 is a diagram illustrating a picture displayed on a display unit 620 of a vehicle management center 600 in a vehicle management system according to an embodiment of the present invention.

Referring to FIG. 5, the display unit 620 suitably displays the position of the specified vehicle for each time zone.

For example, the vehicle (inherent identification number S9103) was located in the 1-01 block of the first area at 1:15 PM, May 1, 2010, was located in the 1-04 block of the first area at 2:20 PM, May 1, 2010, was located in the 2-03 block of the second area at 12:30 PM, May 2, 2010, and was located in the 3-05 block of the third area at 9:05 AM, May 4, 2010.

Also, the vehicle (inherent identification number K5143) was located in the 3-24 block of the third area at 10:05 AM, May 4, 2010, and was located in the 1-52 block of the first area at 9:05 PM, May 4, 2010.

As described herein, the display unit 620 of the vehicle management system according to an exemplary embodiment of the present invention visually displays the position of the vehicle for each time zone, and thus the user can easily seize the current and past positions of all the vehicles managed by the user.

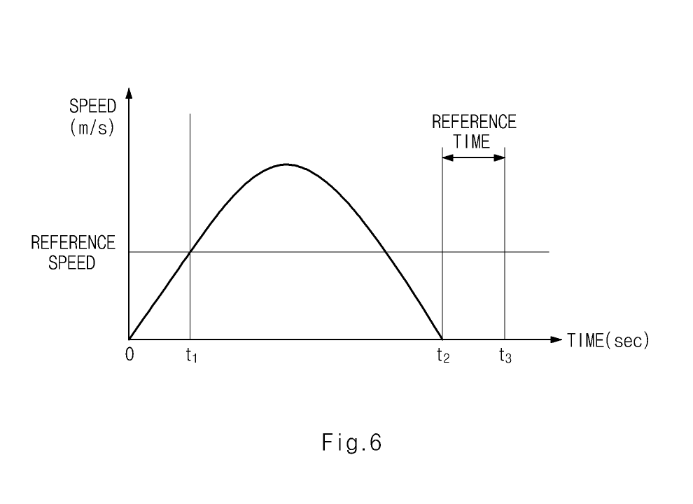

According to certain exemplary embodiments and as shown in FIG. 6, for example, FIG. 6 is a graph showing a process in which a mobile vehicle management device 200 recognizes the movement of a vehicle 400 in a vehicle management system according to an embodiment of the present invention.

Referring to FIG. 6, the vehicle 400 suitably increases speed at a standstill state to move, reduces the speed, and then is stopped.

In preferred embodiments, it is assumed that time required for reaching a reference speed from the standstill state of the vehicle 400 is t1.

In further preferred embodiments, the reference speed is a speed that is the basis of judging the movement of the vehicle 400, and can be set according to a user's intention.

At t1, the RFID reader 210 of the mobile vehicle management device 200 suitably communicates with the RFID tag 300 of the vehicle 400 to receive the vehicle information. Preferably, the received vehicle information is stored in the register 250.

As the moving speed of the vehicle 400 is first increased and then is reduced, the vehicle 400 is stopped at t2. Whether the vehicle 400 is stopped can be judged by analyzing the position information. For example, in certain exemplary embodiments, if the GPS coordinate value that is the position information is not changed with the lapse of time, it may be judged that the vehicle 400 is suitably stopped.

In further preferred embodiments, the management information generation unit 230 of the mobile vehicle management device 200 starts to judge whether the reference time elapses from t2.

Preferably, if the position information value of the vehicle that is received for the reference time from t2 is not changed or the changed position information value is smaller than the reference value, it is judged that the vehicle 400 is not moved any further.

Preferably, at t3 when the reference time elapses from t2, the management information generation unit 230 of the mobile vehicle management device 200 simultaneously or sequentially combines the vehicle information and the position information at t3 to generate the management information.

Preferably, the management information transmitting unit 240 transmits the management information to the server 100.

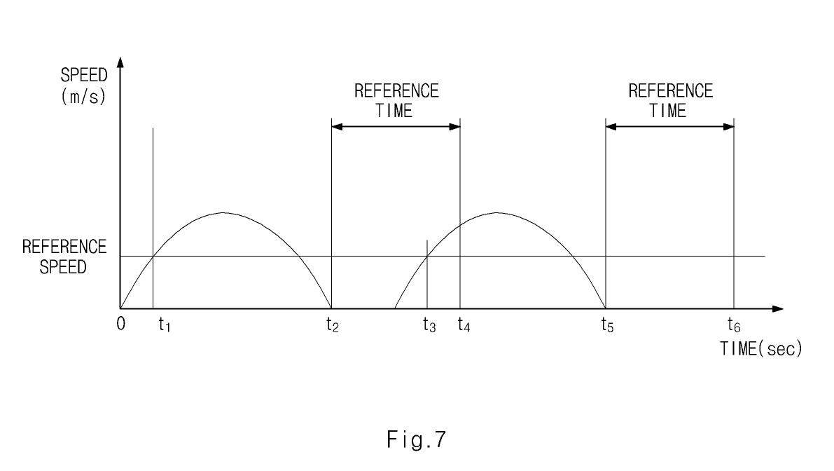

According to certain exemplary embodiments and as shown in FIG. 7, for example, FIG. 7 is a graph showing another process in which a mobile vehicle management device 200 recognizes the movement of a vehicle 400 in a vehicle management system according to an embodiment of the present invention.

Referring to FIG. 7, the vehicle 400 increases speed at a standstill state to move, reduces the speed, and then is stopped. Then, the vehicle 400 increases the speed again to move, reduces the speed, and then is stopped.

According to preferred exemplary embodiments, it is assumed that time required for reaching the reference speed from the standstill state of the vehicle 400 is t1.

Preferably, the reference speed is a speed that is the basis of judging the movement of the vehicle 400, and can be set according to a user's intention.

At t1, the RFID reader 210 of the mobile vehicle management device 200 suitably communicates with the RFID tag 300 of the vehicle 400 to receive the vehicle information. Preferably, the received vehicle information is stored in the register 250.

According to further preferred embodiments of the present invention, as the moving speed of the vehicle 400 is first increased and then is reduced, the vehicle 400 is suitably stopped at t2. Preferably, whether the vehicle 400 is suitably stopped can be judged by analyzing the position information. For example, in certain preferred embodiments, if the GPS coordinate value that is the position information is not changed with the lapse of time, it may be judged that the vehicle 400 is suitably stopped.

According to further preferred embodiments of the present invention, the management information generation unit 230 of the mobile vehicle management device 200 starts judgment of whether the reference time elapses from t2.

Preferably, if the position information value of the vehicle 400 that is received for the reference time from t2 is not suitably changed or the changed position information value is suitably smaller than the reference value, it is judged that the vehicle 400 is not moved any further.

However, as shown in FIG. 7, for example, if the moving speed of the vehicle 400 exceeds the reference speed at t3 that is before the reference time elapses from t2, it is judged that the vehicle 400 continues movement, and thus the management information is not suitably generated.

Preferably, as the moving speed of the vehicle 400 is increased and then is reduced, the vehicle 400 is stopped again at t5. Whether the vehicle 400 is stopped can be judged by analyzing the position information. For example, according to certain exemplary embodiments, if the GPS coordinate value that is the position information is not changed with the lapse of time, it may be judged that the vehicle 400 is stopped.

Further, in certain preferred embodiments, the management information generation unit 230 starts judgment of whether the reference time elapses from t5.

Preferably, if the position information value of the vehicle 400 is not changed for the reference time from t5 or the changed position information value is smaller than the reference value, it is judged that the vehicle 400 is not moved any further.

According to certain exemplary embodiments and as shown in FIG. 7, the management information generation unit 230 generates the management information by combining the position information that is received by the position information receiving unit 220 at t6 when the reference time elapses from t5 with the vehicle information stored in the register 250.

In certain preferred embodiments, if the moving speed of the vehicle 400 is suitably lowered below the reference speed and then is suitably increased over the reference speed at t3, the RFID reader 210 of the mobile vehicle management device 200 communicates again with the RFID tag 300.

Preferably, the RFID reader 210 compares the vehicle information received from the RFID tag 300 at t3 with the vehicle information stored in the register 250.

According to further preferred embodiments, if the received vehicle information is the same as the stored vehicle information as the result of comparison, the management information generation unit 230 judges that the same vehicle 400 continues movement, and performs the above-described management operation.

In other further embodiments, if the received vehicle information is different from the stored vehicle information as the result of comparison, this means that the mobile vehicle management device 200 manages a different vehicle 400, and thus the management information generation unit 230 generates the management information by combining the vehicle information stored in the register 250 and the position information received at t2. The management information generation unit 230 stores new vehicle information in the register 250, and performs the above-described management operation with respect to the corresponding vehicle.

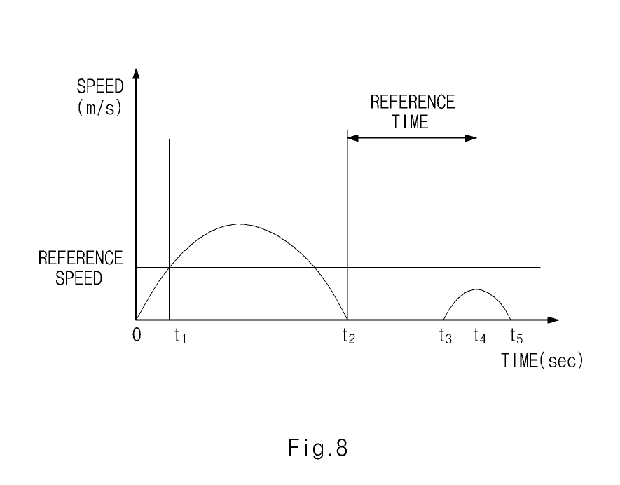

According to certain exemplary embodiments and as shown in FIG. 8, for example, FIG. 8 is a graph showing still another process in which a mobile vehicle management device 200 recognizes the movement of a vehicle 400 in a vehicle management system according to an embodiment of the present invention.

Referring to FIG. 8, the vehicle 400 increases speed at a standstill state to move, reduces the speed, and then is stopped. Then, the vehicle 400 increases the speed again to move, reduces the speed, and then is stopped.

According to still further exemplary embodiments, it is assumed that time required for reaching the reference speed from the standstill state of the vehicle 400 is t1.

Preferably, the reference speed is a speed that is the basis of judging the movement of the vehicle 400, and can be set according to a user's intention.

At t1, the RFID reader 210 of the mobile vehicle management device 200 communicates with the RFID tag 300 of the vehicle 400 to receive the vehicle information. The received vehicle information is stored in the register 250.

According to certain preferred embodiments, as the moving speed of the vehicle 400 is first increased and then is reduced to be equal to the reference speed at t2. Whether the vehicle 400 is stopped can be judged by analyzing the position information. For example, if the GPS coordinate value that is the position information is not changed with the lapse of time, it may be judged that the vehicle 400 is stopped.

Preferably, the management information generation unit 230 of the mobile vehicle management device 200 starts judgment of whether the reference time elapses from t2.

Preferably, if the position information value of the vehicle 400 that is received for the reference time from t2 is not changed or the changed position information value is smaller than the reference value, it is judged that the vehicle 400 is not moved any further.

In FIG. 8, although the moving speed of the vehicle 400 is increased at t3 that is before the reference time elapses from t2, it is still below the reference speed. In this case, the management information generation unit 230 judges that the vehicle 400 is not moved any further.

According to further embodiments of the invention, since the vehicle 400 is not moved any further from t2 to t4 when the reference time elapses, the management information generation unit 230 generates the management information by combining the position information received by the position information receiving unit 220 at t4 with the vehicle information stored in the register 250.

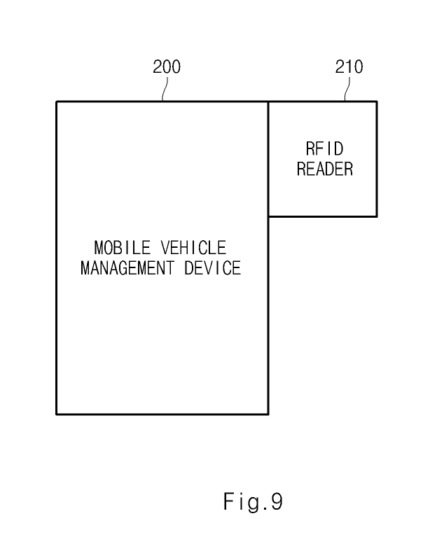

According to certain exemplary embodiments and as shown in FIG. 9, for example, FIG. 9 is a diagram illustrating the configuration of another example of a vehicle management center 200 in a vehicle management system according to an embodiment of the present invention.

In FIG. 3, the mobile vehicle management device 200 includes the RFID reader 210. However, according to certain preferred embodiments, the RFID reader 210 is not necessarily included in the mobile vehicle management device 200, and may be installed outside the mobile vehicle management device 200.

Referring to FIG. 9, the RFID reader 210 is suitably installed outside the mobile vehicle management device 200. If the RFID reader 210 is installed outside the mobile vehicle management device 200, an antenna of the RFID reader 210 is located outside the mobile vehicle management device 200. In this case, the communication with the RFID tag 300 can be performed more efficiently.

In addition, in the case where the RFID reader 210 is suitably provided inside the mobile vehicle management device 200, the arrangement of the RFID reader in relation to internal constituent elements of the mobile vehicle management device 200 should be considered. However, in the case where the RFID reader is installed outside the mobile vehicle management device 200, it is not required to consider the arrangement of the RFID reader in the mobile vehicle management device.

In addition, in the case of installing the RFID reader 210 outside the mobile vehicle management device 200, it is not required to separately produce the mobile vehicle management device 200, and the RFID reader 210 may be attached to a typical mobile communication device, such a mobile phone, PDA (Personal Digital Assistant), or the like, so that the mobile communication device can be used as the mobile vehicle management device 200.

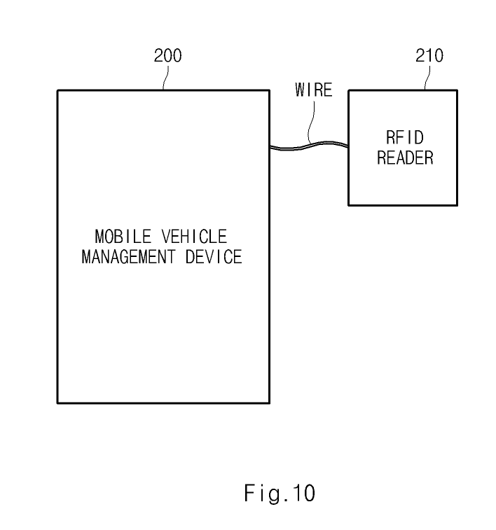

According to certain exemplary embodiments and as shown in FIG. 10, for example, FIG. 10 is a diagram illustrating the configuration of still another example of a vehicle management center 200 in a vehicle management system according to an embodiment of the present invention.

Referring to FIG. 10, the RFID reader 210 is connected to the outside of the mobile vehicle management device 200 through wires.

According to certain preferred embodiments, if the RFID reader 210 is suitably connected to the outside of the mobile vehicle management device 200 through wires, the antenna of the RFID reader 210 is located outside the mobile vehicle management device 200. In this case, the communication with the RFID tag 300 can be performed more efficiently.

In addition, in the case where the RFID reader 210 is suitably provided inside the mobile vehicle management device 200, the arrangement of the RFID reader in relation to internal constituent elements of the mobile vehicle management device 200 should be considered. However, in the case where the RFID reader is connected to the outside of the mobile vehicle management device 200 through the wires, it is not required to consider the arrangement of the RFID reader in the mobile vehicle management device.

In still other further preferred embodiments, in the case of connecting the RFID reader 210 to the outside of the mobile vehicle management device 200 through the wires, it is not required to separately produce the mobile vehicle management device 200, and the RFID reader 210 may be connected to the typical mobile communication device, such as, but not limited to, a mobile phone, PDA, or the like, through the wires, so that the mobile communication device can be used as the mobile vehicle management device 200.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A vehicle management system comprising:
an RFID tag storing vehicle information;
a mobile vehicle management device generating management information from position information and the vehicle information received from the outside; and
a server generating operation information by analyzing the management information.

2. The vehicle management system of claim 1, wherein the mobile vehicle management device comprises:
an RFID reader receiving the vehicle information by communicating with the RFID tag;
a position information receiving unit receiving the position information from the outside;
a management information generation unit generating the management information from the vehicle information and the position information; and
a management information transmitting unit transmitting the management information to the server.

3. The vehicle management system of claim 1, wherein the server comprises:
a communication unit receiving the management information;
a management information analysis unit seizing the position information and the vehicle information by analyzing the management information;
an operation information generation unit generating the operation information from the position information and the vehicle information; and
a storage unit storing the position information, the vehicle information, the management information, and the operation information.

4. The vehicle management system of claim 1, wherein the vehicle information comprises an inherent identification number of the vehicle.

5. The vehicle management system of claim 1, wherein the position information comprises GPS position coordinates of the vehicle.

6. The vehicle management system of claim 1, wherein the operation information comprises information on one or more of the position of the vehicle for each time zone, a moving path, and a moving speed.

7. The vehicle management system of claim 1, wherein the mobile vehicle management device is activated when the vehicle is moved at a speed that is higher than a reference speed.

8. The vehicle management system of claim 7, wherein if the vehicle is stopped over the reference time in a state where the mobile vehicle management device is activated, the mobile vehicle management device generates and transmits the management information to the server.

9. The vehicle management system of claim 7, wherein the mobile vehicle management device receives the vehicle information from the RFID tag whenever the mobile vehicle management device is activated.

10. The vehicle management system of claim 9, wherein the mobile vehicle management device further comprises a register storing the vehicle information and the position information.

11. The vehicle management system of claim 10, wherein the mobile vehicle management device compares the vehicle information stored in the register with the vehicle information received from the RFID tag when the mobile vehicle management device is activated.

12. The vehicle management system of claim 1, wherein the RFID reader connected to the mobile vehicle management device is an external RFID reader.

13. A vehicle management system comprising:
an RFID tag storing vehicle information;
a mobile vehicle management device; and
a server that generates operation information.

14. The vehicle management system of claim 13, wherein the mobile vehicle management device generates management information from position information and the vehicle information received from the outside.

15. The vehicle management system of claim 13, wherein the server generates operation information by analyzing the management information.
